(19) United States
(12) Patent Application Publication
(10) Pub. No.: US 2005/0004603 A1
(43) Pub. Date: Jan. 6, 2005

(54) Teether toy and method of use

(76) Inventors: Vasco Desousa, Pawtucket, RI (US); Joseph F. Brewin, Franklin, MA (US); Candy Siu, Kwun Tong (HK)

Correspondence Address: FISH & RICHARDSON PC, 225 FRANKLIN ST, BOSTON, MA, 02110, US

(21) Appl. No.: 10/612,728

(22) Filed: Jul. 2, 2003

(51) Int. Cl. A61J 17/00

(52) U.S. Cl. 606/235

(57) ABSTRACT

A baby teether includes a graspable housing having a cavity therein and a positionable member rotatably connected to the housing and partially disposed within the housing cavity. The positionable member includes a teething portion defining a teething surface that spans a limited extent of a periphery of the positionable member. The positionable member is rotatable with respect to the housing to selectively expose the teething surface for use and to cover the teething surface for storage.

### TECHNICAL FIELD

This invention relates to teethers for stimulating gums of small children, and to toys for such children.

### BACKGROUND

A small child frequently plays with numerous items, for example, pacifiers, toys, etc. throughout the course of a day. To have the items available for the small child, an adult (e.g., a parent) must transport various items along with the child. One item frequently transported along with the child is a teether, which can be used to stimulate the gums of the child. Because the teether is placed within the mouth of the child, there is a concern about the general level of cleanliness of the teether, including germs that may collect on the teether, particularly when the teether is not in use.

### SUMMARY

This invention provides means for protecting a teething surface when not in use without the need for a separate storage device.

In an aspect, the invention features a baby teether that includes a graspable housing having a cavity therein. A positionable member is rotatably connected to the housing and partially disposed within the housing cavity. The positionable member includes a teething portion defining a teething surface spanning a limited extent of a periphery of the positionable member. The positionable member is rotatable with respect to the housing to selectively expose the teething surface for use and to cover the teething surface for storage.

In another aspect, the invention features a method of using the baby teether that includes providing the baby teether described above and rotating the positionable member to position the teething surface outside the housing for use.

This aspect may include rotating the positionable member to position the teething surface within the housing.

Any of the above aspects may contain one or more of the following features. For example, the positionable member of the baby teether can have a rattle portion spanning an opposite extent of the periphery of the positionable member. The rattle portion may include a rattle cavity therein. Noise elements may be loosely contained within the rattle cavity for making noise audible from outside the teether. A wall of the rattle portion may be transparent where, in some cases, noise elements are visible from outside the teether. In some cases, the teething surface and a surface of the rattle portion are of different materials. The teething surface may be softer than the surface of the rattle portion. The teething surface can be made of a teething material having a durometer of at most about 80 Shore A, where the surface of the rattle portion has a durometer greater than the durometer of the teething material.

In some embodiments, the teething portion has a sealed cavity therein. Liquid may be contained within the sealed cavity. The liquid can be water, such as drinking water

In some cases, the positionable member can be a wheel connected to the housing, the wheel adapted to rotate relative to the housing about a central axis of the wheel. In some embodiments, the positionable member is freely rotatable with respect to the housing. In some cases, the baby teether includes a handle extending outwardly from the housing. The handle may include a textured teething surface. In some embodiments, the teething surface of the baby teether is textured for gum stimulation. In some cases, the teething surface of the baby teether includes discrete ribs extending therefrom.

The above-described teether provides advantages. For example, the teething surface can be positioned within the housing to reduce exposure of the teething surface to, for example, dust, dirt, etc. The teether may be stored without use of a separate storage device. In some cases, by transforming the teether from one mode to another mode, the teether provides a variety of modes for the baby's enjoyment.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a front view of a teether with an exposed teething surface.

FIG. 1B is a front view of the teether of FIG. 1A with an exposed rattle and a covered teething surface.

FIG. 2 is a rear view of the teether of FIG. 1A.

FIG. 3 is an exploded view of a positionable member.

FIG. 4 is an exploded view of the teether of FIG. 1A.

Like reference symbols in the various drawings indicate like elements.

### DETAILED DESCRIPTION

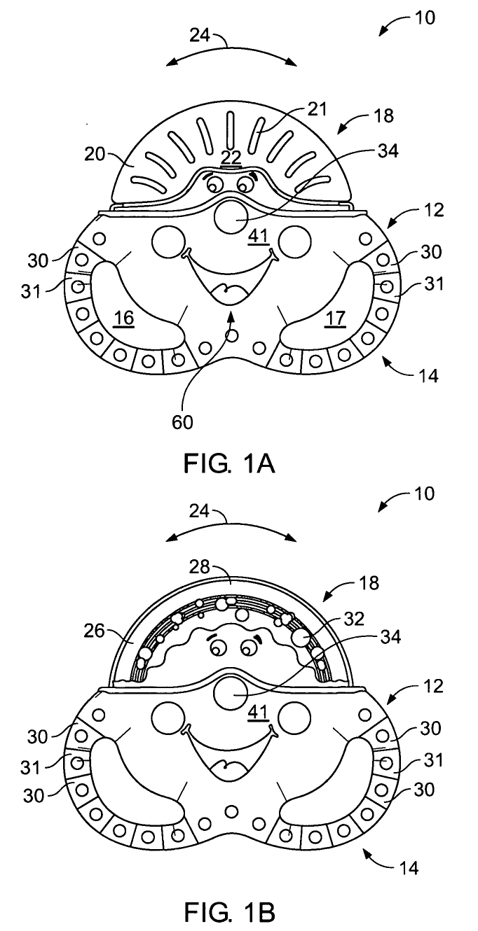

Referring to FIGS. 1A-2 and 4, a teether 10 includes a graspable housing 12 with a handle 14. Referring particularly to FIG. 1A, handle 14 is w-shaped forming a pair of openings 16 and 17. A positionable member 18 is rotatably connected within housing 12. Positionable member 18 includes a teething portion 20 that has a teething surface 22 suitable for teething by a baby. Teething portion 20 includes ribs 21 extending outwardly from teething surface 22 that provide texture to teething surface 22. Other gum-stimulating textures, such as bumps or depressions, are also envisioned. Teething surface 22 spans a limited extent about positionable member 18, e.g., about half of a periphery or less of the positionable member 18. As can be seen, positionable member 18 is positioned partially within housing 12 such that a portion, in this case teething surface 22, is exposed and a portion of positionable member 18 is covered to form a teething mode. The portion that is covered can be a member different than teething portion 20, which can be utilized or played with by the baby when exposed, the details of which will be described in greater detail below.

Positionable member 18 is rotatably connected within housing 12. This rotational connection allows for selective exposure and covering of, for example, teething surface 22 of teething portion 20. Positionable member 18 is capable of rotating about an axis of rotation, in opposing directions, as indicated by arrow 24. Positionable member 18 can be rotatable less than 360 degrees (e.g., about 180 degrees) by providing appropriate rotation stops (not shown), about 360 degrees and/or positionable member 18 can be freely rotatable about the axis of rotation.

FIG. 1B shows teether 10 in a rattle mode, in which positionable member 18 has been rotated about the axis of rotation in a direction of arrow 24 to expose a rattle portion 26 that spans a limited extent about positionable member 18, e.g., about half of the periphery or less of the positionable member 18. Rattle portion 26 has an outer surface 28 and a rattle cavity. Rattle cavity includes a number of noise elements 32 that, during use, can collide against an inner surface of the cavity to produce an audible noise, e.g., a rattling sound. Preferably, walls of rattle portion 26 are transparent, for viewing brightly colored noise elements 32 in a play mode.

Preferably, rattle portion 26 is formed of a plastic (e.g., polycarbonate, etc.) and teething portion 20 is also preferably formed of a plastic (e.g., ethylene-vinyl acetate (EVA), tetrafluoroethylene (TFE), polyvinyl chloride (PVC), etc.). In some cases, the material of teething portion 20 has a lower durometer than the material of rattle portion 26. The higher durometer material of rattle portion 26 can provide a more suitable rattling sound, while the lower durometer material (e.g., at most about 80 Shore A, such as from about 60 to 80 Shore A) of teething portion 20 can provide a more suitable teething surface 22. The material of rattle and/or teething portion 26, 20 can be transparent, semi-transparent, opaque, dyed, and/or the like.

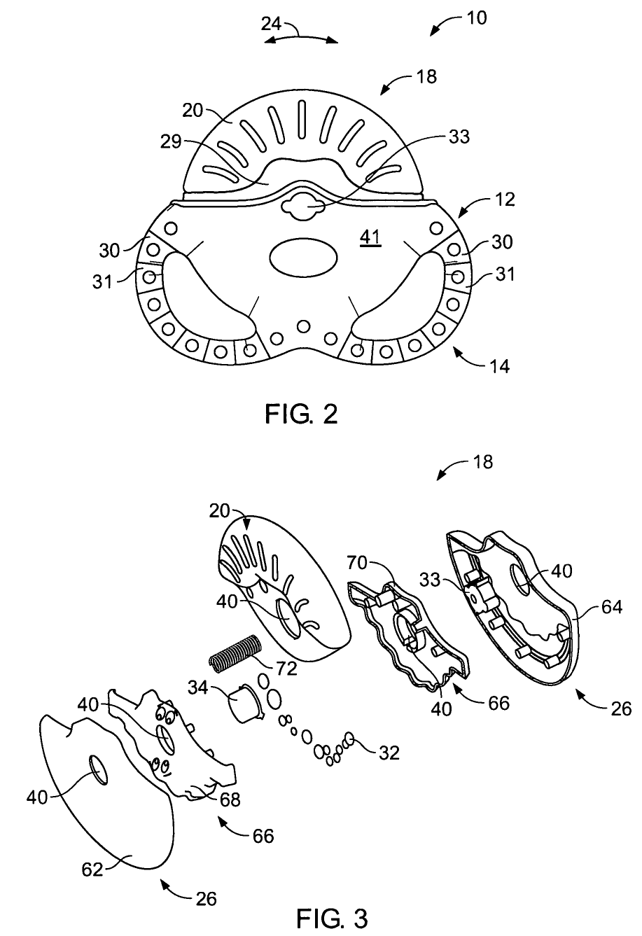

In some embodiments, housing 12 is formed of materials of different durometers. By utilizing materials of different durometers, parts of housing 12 can be teethable by the baby while still providing a relatively rigid housing structure. Referring to FIGS. 1A-2, sections 30 of handle 14 are formed of a lower durometer material (e.g., at most about 80 Shore A, such as between about 60 to 80 Shore A), such as, e.g., ethylene-vinyl acetate (EVA), tetrafluoroethylene (TFE), polyvinyl chloride (PVC), etc., while sections 31 of handle 14 are formed of a higher durometer material (e.g., styrene including acrylonitrile-butadiene-styrene (ABS), polypropylene, etc.). Alternatively, all of housing 12 can be formed of either a lower or a higher durometer material.

In some embodiments, teething portion 20 includes an inner, enclosed cavity (not shown). Desirably, the inner cavity of teething portion 20 is filled, at least partially, with a liquid or gel. As used herein, the term liquid includes gel. The liquid contained within the cavity can be cooled to provide a cooled teething surface 22 for teething by the baby, such as by placing teether 10 in a refrigerator. Suitable liquids include, for example, drinking water and/or other non-toxic liquids. In some cases, the liquid is cooled (e.g., between about 38 to 45 degrees, such as 40 degrees). In some embodiments, the cavity can be empty or teething portion 20 can be solid throughout.

FIG. 3 shows an exploded view of positionable member 18. Rattle portion 26 includes a front member 62 and an interlocking rear member 64. An inner member 66, positioned between front and rear members 62 and 64 of rattle portion 26, also includes a front member 68 and an interlocking rear member 70. Teething portion 20 is of unitary construction and is foamed to be partially positioned within inner member 66, sandwiched between front and rear members 68 and 70.

Each of rattle portion 26, teething portion 20 and inner member 66 include apertures 40 that are aligned to allow buttons 33 and 34 to extend therethrough. As will be described below, buttons 33 and 34 are depressible, biased in an extended position by spring 72, and serve, at least in part, to connect the rattle, teething and inner members together. In some embodiments, teething portion 20, inner member 66 and/or rattle portion 26 are welded, such as by ultrasonic welding. In some cases, an adhesive is used. In some embodiments, mechanical connections (e.g., pins, bosses, screws, beaded connections, detents, snaps, etc.) are used. In some cases, combinations of the above connections are utilized. For example, in some embodiments, front member 68 and rear member 70 are connected by a pin and boss mechanical connection with the pin adhered within the boss. Then, the members 68 and 70 can be ultrasonically welded together.

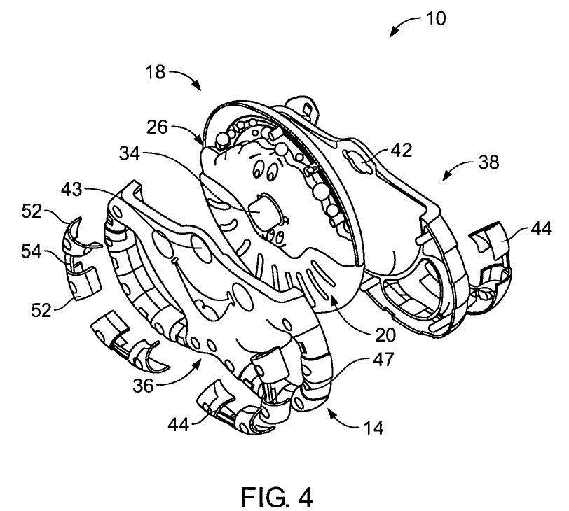

Referring now to FIG. 4, an exploded view of teether 10 is shown. Positionable member 18, including assembled teething and rattle portions 20 and 26, is in the form of a wheel having a first button 34 extending from about the center of a front surface 27 and a second, keyed button 33 extending from a back surface 29 of positionable member 18 (see FIG. 2). Each of buttons 33 and 34 are depressible and biased toward an extended position by spring 72 (see also FIG. 3). In some cases, only one button is depressible. In some embodiments, neither button is depressible. Housing 12 includes a first section 36 and an interconnecting second section 38. First and second sections 36, 38 have apertures 43, 42 sized to receive first and second buttons 34 and 33 to form the axis of rotation of positionable member 18 relative to housing 12.

As shown, positionable member can lock at a predetermined angular position using keyed second button 33 and aperture 42 (see FIG. 2). By locking into a particular angular position, the possibility that a baby might unintentionally transform teether 10 from one mode, e.g., the teething mode, to another mode is reduced. While keyed button 33 and corresponding aperture 42 are shown, any number of other suitable mechanisms can be employed to lock and/or catch positionable member 18 at a predetermined position (e.g., notches, detents, snaps, etc.).

In some embodiments, once teether 10 is assembled, buttons 33 and/or 34 are sized so that an end 35 of buttons 33 and/or 34 is about flush with an outer surface 41 of housing 12. In some cases, a cap (not shown) can be positioned within apertures 43 and/or 42 and sized to receive buttons 33 and/or 34. By providing the cap, buttons 33 and/or 34 will not be exposed to the baby during use.

In some embodiments, first and second sections 36, 38 are welded, such as by ultrasonic welding. Adhesives can also be used. In some embodiments, mechanical connections (e.g., pins, bosses, screws, beaded connections, detents, snaps, etc.) are employed. In some cases, combinations of the above connections are utilized. For example, in some embodiments, first section 36 and second section 38 are connected by a pin and boss mechanical connection with the pin adhered within the boss. Then, sections 36 and 38 can be ultrasonically welded together. Positionable member 18, first and second housing sections 36, 38 are preferably formed by molding techniques such as injection molding, as an example.

Teething components 44, having a durometer less than the housing 12, are connected to handle 14 forming sections 30 of lower durometer, as described above. Teething components 44 are a pair of U-shaped brackets 52 interconnected by a beam 54.

In some embodiments, teething components are over molded at desired locations on handle 14. Handle 14 includes openings 47 that allow mold material to pass therethrough to further secure teething components 44 to handle 14. Any number of other suitable methods can be used to connect teething components 44 to handle 14 (e.g., mechanical connections such as detents, snaps, adhesives, welding such as ultrasonic welding, etc.).

As can most clearly be seen by FIGS. 1A and 1B, teether 10 includes a design 60 in the form of a facial expression. A portion of the facial expression is positioned on housing 12. In particular, a mouth and cheeks are provided on housing 12, a nose of the facial expression is formed by button 34 that is visible through aperture 43 in housing 12. Eyes of the facial expression are provided on positionable member 18. Referring now to FIG. 4, two pairs of eyes are provided, each positioned on inner member 66. One pair of eyes is visible in teething mode and one pair is visible in rattle mode providing a complete facial expression when teether 10 is placed in either teething mode or rattle mode. As shown, a pair of eyes is provided on inner member 66, which is visible through rattle portion 26. In some embodiments, both pairs or only one pair of eyes is provided on rattle portion 26. In some cases, one pair of eyes is different than the other pair of eyes. This allows for displaying different facial expressions depending on whether teether 10 is in teething mode or rattle mode.

In operation, teether 10 can be rotated relative to housing 12 from a locked position by depressing keyed button 33 and rotating positionable member 18. Positionable member 18 can be rotated to a different position where aperture 42 receives biased keyed button 33, locking positionable member 18. In some cases, positionable member 18 is removable by depressing both buttons 33 and 34 and removing positionable member 18 from within housing 12.

A number of embodiments of the invention have been described. Nevertheless, it will be understood that various modifications may be made without departing from the spirit and scope of the invention. For example, instead of a rattle portion, the positioning component can include any suitable member for entertaining and/or soothing a child. Accordingly, other embodiments are within the scope of the following claims.

1. A baby teether comprising:
a graspable housing defining a cavity therein; and
a positionable member rotatably connected to the housing and partially disposed within the housing cavity, the positionable member including a teething portion defining a teething surface spanning a limited extent of a periphery of the positionable member;
the positionable member rotatable with respect to the housing to selectively expose the teething surface for use and to cover the teething surface for storage.

2. The baby teether of claim 1, wherein the positionable member further includes a rattle portion spanning an opposite extent of the periphery of the positionable member.

3. The baby teether of claim 2, wherein the rattle portion defines a rattle cavity therein.

4. The baby teether of claim 3, further including noise elements loosely contained within the rattle cavity.

5. The baby teether of claim 2, wherein a wall of the teething portion is transparent.

6. The baby teether of claim 5, wherein the rattle portion defines a rattle cavity therein having noise elements loosely contained within the rattle cavity, the noise elements visible from outside the teether.

7. The baby teether of claim 2, wherein the teething surface and a surface of the rattle portion are of different materials.

8. The baby teether of claim 7, wherein the teething surface is softer than the surface of the rattle portion.

9. The baby teether of claim 2, wherein the teething surface comprises a teething material having a durometer of at most about 80 Shore A, a surface of the rattle portion having a durometer greater than the durometer of the teething material.

10. The baby teether of claim 1, wherein the teething portion defines a sealed cavity therein.

11. The baby teether of claim 10 further including a liquid contained within the sealed cavity.

12. The baby teether of claim 11, wherein the liquid comprises water.

13. The baby teether of claim 1, wherein the positionable member comprises a wheel connected to the housing, the wheel arranged to rotate relative to the housing about a central axis of the wheel.

14. The baby teether of claim 1, wherein the positionable member is freely rotatable with respect to the housing.

15. The baby teether of claim 1 further including a handle extending outwardly from the housing.

16. The baby teether of claim 15, wherein the handle has a textured teething surface.

17. The baby teether of claim 1, wherein the teething surface is textured for gum stimulation.

18. The baby teether of claim 1 the teething surface includes discrete ribs extending therefrom.

19. A method of providing a teething surface for a baby comprising:
providing the baby teether of claim 1; and
rotating the positionable member to position the teething surface outside the housing for use.

20. The method of claim 19 further including rotating the positionable member to position the teething surface within the housing.
